(19) United States
(12) Patent Application Publication
(10) Pub. No.: US 2018/0034749 A1
(43) Pub. Date: Feb. 1, 2018

(54) SYSTEM AND METHOD FOR DISTRIBUTING AND REPLAYING TRIGGER PACKETS VIA A VARIABLE LATENCY BUS INTERCONNECT

(71) Applicant: QUALCOMM INCORPORATED, SAN DIEGO, CA (US)

(72) Inventor: MARTYN RYAN SHIRLEN, WAKE FOREST, NC (US)

(21) Appl. No.: 15/224,735

(22) Filed: Aug. 1, 2016

(51) Int. Cl. H04L 12/861; H04L 12/863; H04L 12/923; H04L 12/933; H04L 29/06

(52) U.S. Cl. CPC H04L 49/9057; H04L 49/109; H04L 69/28; H04L 47/762; H04L 47/6245

(57) ABSTRACT

Systems and methods are disclosed for distributing and replaying trigger packets via a variable latency bus interconnect in a trace system. An embodiment of such a method comprises generating a plurality of trigger packets from a plurality of trigger sources on a system on chip. Each trigger packet defines a corresponding event and a corresponding system-generated timestamp. The plurality of trigger packets are distributed from the corresponding trigger sources to a centralized logic analyzer via a variable latency bus interconnect. The received triggered packets are re-ordered according to the corresponding system-generated timestamps into an order in which the corresponding events occurred. The received trigger packets are replayed in the order in which the corresponding events occurred.

### DESCRIPTION OF THE RELATED ART

Many computing devices, including personal computers, servers, and portable computing devices (e.g., mobile phones, table computers, portable game consoles, navigation devices, wearable devices, and other battery-powered devices) include a system on chip (SoC). A design approach typically used in developing these types of devices is to develop integrated circuits to support various functions. The desired operational performance, usability and market success of a computing device may be directly determined by the software that is developed to run on the programmable subsystems of the computing device.

System trace and debugging systems have been developed to expose various characteristics of the operation of the system to the software and hardware development teams. Such embedded trace systems include a number of SoC peripherals such as cells or circuit modules for processing and buffering trace data. Some of these SoC peripherals insert a timestamp into a trace data stream. These conventional time stamping techniques have included the insertion of a timestamp in a native trace packet layer that corresponds to the trace protocol being used by the trace source. A native trace packet layer includes a set of packet-based protocols for tracing the operation of various hardware cores. Each packet-based trace protocol is able to differentiate between trace sources, recognize instructions, arguments, timestamps, and other performance monitoring data.

Many server and higher-end mobile SoCs have a strong need for cheap cycle accurate logic analyzer style cross triggering. “Logic analyzer style” triggering refers to triggering capabilities that enable logic analyzers to observe real-time behavior of a number of SoC pins connected to the logic analyzer. Many existing SoCs have limited capabilities to bring all of the tens to hundreds of thousands of internal signals of interest to primary pins for external logic analyzer observation. Trace capture memory typically exists in one or more points in the SoC. The logic analyzer trigger functionality may comprise a hardware block within the SoC that is connected to a number of internal signals that are suspected to be useful to generating relevant triggering scenarios that may be used for trace capture or other system behavior (e.g., causing an interrupt to a system CPU).

An existing method for performing cycle accurate triggering distributed across the SoC involves including a number of triggering hardware blocks (e.g., trigger generation units (TGUs)) at each point where there are bundles of signals of interest to triggering scenarios. This distributed approach has significant disadvantages. For example, the triggering hardware blocks can be area intensive because they must provide storage for a mini triggering “program”.

Accordingly, there is a need for improved systems and methods for distributing and replaying trigger packets via a variable latency bus interconnect.

### SUMMARY OF THE DISCLOSURE

Systems and methods are disclosed for distributing and replaying trigger packets via a variable latency bus interconnect in a trace system. An embodiment of such a method comprises generating a plurality of trigger packets from a plurality of trigger sources on a system on chip. Each trigger packet defines a corresponding event and a corresponding system-generated timestamp. The plurality of trigger packets are distributed from the corresponding trigger sources to a centralized logic analyzer via a variable latency bus interconnect. The received triggered packets are re-ordered according to the corresponding system-generated timestamps into an order in which the corresponding events occurred. The received trigger packets are replayed in the order in which the corresponding events occurred.

An embodiment of a system comprises a plurality of trigger sources a variable latency bus interconnect, and a centralized logic analyzer. The plurality of trigger sources for generating a plurality of trigger packets, each trigger packet defining a corresponding event and a corresponding system-generated timestamp. The variable latency bus interconnect is electrically coupled to the plurality of trigger sources for distributing the plurality of trigger packets to a centralized logic analyzer. The centralized logic analyzer is configured to: receive the trigger packets via the variable latency bus interconnect; re-order the received trigger packets according to the corresponding system-generated timestamps into an order in which the corresponding events occurred; and replay the received trigger packets in the order in which the corresponding events occurred.

### BRIEF DESCRIPTION OF THE DRAWINGS

In the Figures, like reference numerals refer to like parts throughout the various views unless otherwise indicated. For reference numerals with letter character designations such as “102A” or “102B”, the letter character designations may differentiate two like parts or elements present in the same Figure. Letter character designations for reference numerals may be omitted when it is intended that a reference numeral to encompass all parts having the same reference numeral in all Figures.

FIG. 1 is a block diagram of an embodiment of a trace system for distributing and replaying trigger packets from a plurality of trace sources via a variable latency bus interconnect.

FIG. 2 is a block diagram illustrating an exemplary operation of the re-order/replay unit in the system of FIG. 1.

FIGS. 3a & 3b illustrate exemplary timing diagrams for the trigger packet window timers associated with the trigger packets in FIG. 2

FIG. 4 is a flowchart illustrating an embodiment of a method implemented in the system of FIG. 1 for distributing and replaying trigger packets via the variable latency bus interconnect.

FIG. 5 is a combined block/flow diagram illustrating an exemplary embodiment of the re-order/replay unit of FIGS. 1 & 2.

FIG. 6 is a block diagram of an embodiment of a portable computing device incorporating the trace system of FIG. 1.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the terms “communication device,” “wireless device,” “wireless telephone”, “wireless communication device,” and “wireless handset” are used interchangeably. With the advent of third generation (“3G”) wireless technology and four generation (“4G”), greater bandwidth availability has enabled more portable computing devices with a greater variety of wireless capabilities. Therefore, a portable computing device may include a cellular telephone, a pager, a PDA, a smartphone, a navigation device, or a hand-held computer with a wireless connection or link.

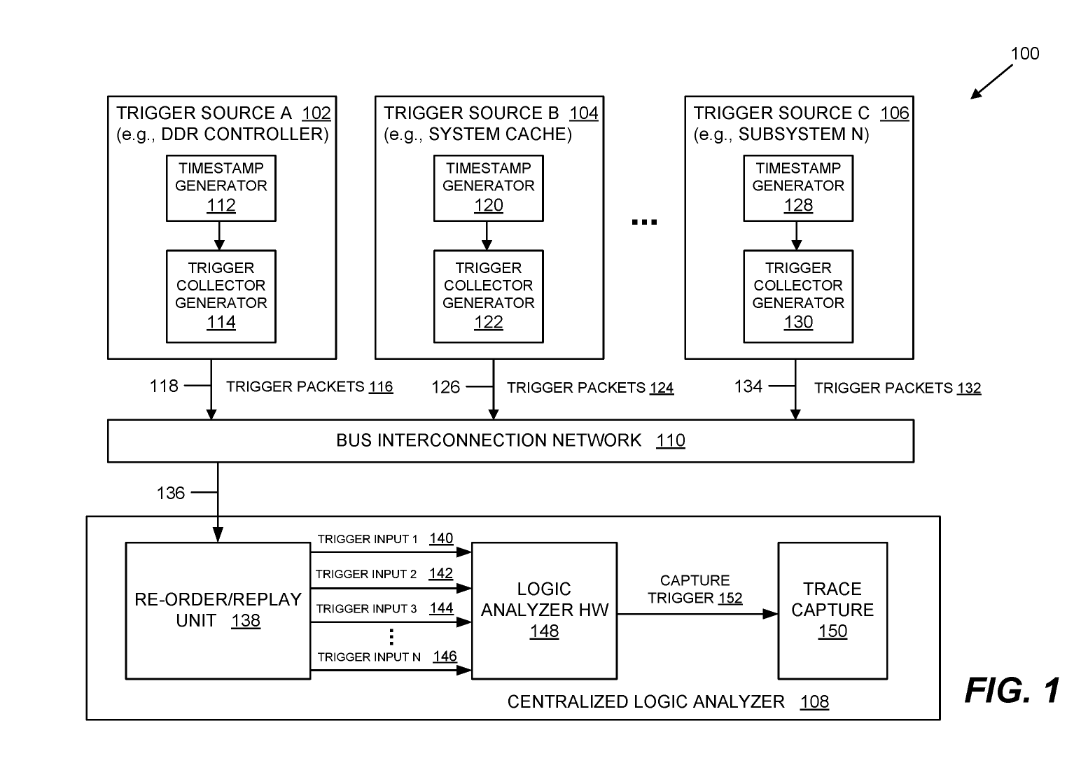

FIG. 1 illustrates an embodiment of a trace system 100 comprising a plurality of trigger sources connected to a centralized logic analyzer 108 via a bus interconnection network 110. It should be appreciated that a trigger source comprises an integrated element on a system on chip (SoC). In the embodiment of FIG. 1, the trace system comprises three trigger sources (i.e., a trigger source A 102, a trigger source B 104, and a trigger source C 106). Trigger source A 102 comprises a memory controller, such as, for example, a double data rate (DDR) controller for controlling a DDR memory electrically coupled to the SoC via a DDR bus. The DDR memory may comprise a dynamic random access memory (DRAM) of any type (e.g., DDR3, DDR4, LPDDR3, LPDDR4, SDRAM, GDDR4, GDDR5, HBM, WideIO2, etc.).

Trigger source B 104 comprises a system cache, which may comprise a multi-level system cache. Trigger source C 106 comprises another subsystem on the SoC. The system 100 may comprise any number (N) of integrated elements or subsystems on the SoC that comprise the trigger sources.

As further illustrated in the embodiment of FIG. 1, each trigger source may include a timestamp generator and a trigger collector generator. It should be appreciated that the trigger sources may be integrated with a corresponding trace source configured to generate a trace stream or, in another embodiment, the trigger functionality may be implemented as separate triggering functionality from the trace stream functionality. Trigger source A 102 comprises a timestamp generator 112 and a trigger collector generator 114. Trigger source B 104 comprises a timestamp generator 120 and a trigger collector generator 122. Trigger source C 106 comprises a timestamp generator 128 and a trigger collector generator 130. As known in the art, the trigger sources 102, 104, and 106 generate data signal(s) indicative of a system event or condition. In response to the occurrence of the monitored system event(s), the timestamp generators 112, 120, and 128 may generate corresponding timestamps to a system clock signal (i.e., system-generated timestamps). It should be appreciated that the timestamp generators 112, 120, and 128 may be configured to respond to any combination of periodic signals, cross trigger events, and/or hardware events from the trace sources, as may be desired.

The timestamp generators 112, 120, and 128 may augment or function in conjunction with the trigger collector generators 114, 122, and 130. As known in the art, the trigger collector generators 114, 122, and 130 may format trace data and generate trigger packets. As illustrated in FIG. 1, the trigger packets may be distributed to the centralized logic analyzer 108 via a variable latency bus interconnect 110. Trigger collector generator 114 may provide trigger packets 116 to the bus interconnect 110 via a connection 118. Trigger collector generator 122 may provide trigger packets 124 to the bus interconnect 110 via a connection 126. Trigger collector generator 130 may provide trigger packets 116 to the bus interconnect 110 via a connection 134.

As further illustrated in FIG. 1, the trigger packets 116, 124, and 132 are distributed through the bus interconnect 110 and received by the centralized logic analyzer 108 via a connection 136. The centralized logic analyzer 108 comprises a re-order/replay unit 138, a logic analyzer 148, and a trace capture block 150. Due to the variable latency of the bus interconnect 110, the trigger packets 116, 124, and 132 may be received out of order relative to the system-generated timestamps which identify when the corresponding events occurred. As described below in more detail, the re-order/replay unit 138 re-orders the received trigger packets according to the corresponding system-generated timestamps into the order in which the corresponding events occurred. The re-ordered trigger packets may be replayed to the trace capture block 150 in the order in which the corresponding events occurred.

The re-order/replay unit 138 may provide a trigger input signal for each trace source to the logic analyzer hardware 148. For example, a trigger input 1 signal 140 may correspond to a first trace source. Trigger input 2 signal 142 may correspond to a second trace source. Trigger input 3 signal 144 may correspond to a third trace source. Trigger input N signal 146 may correspond to an Nth trace source. The logic analyzer hardware 148 receives the trigger input signals 140, 142, 144, and 146 and, in response, provides a capture trigger signal 152 to the trace capture block 150.

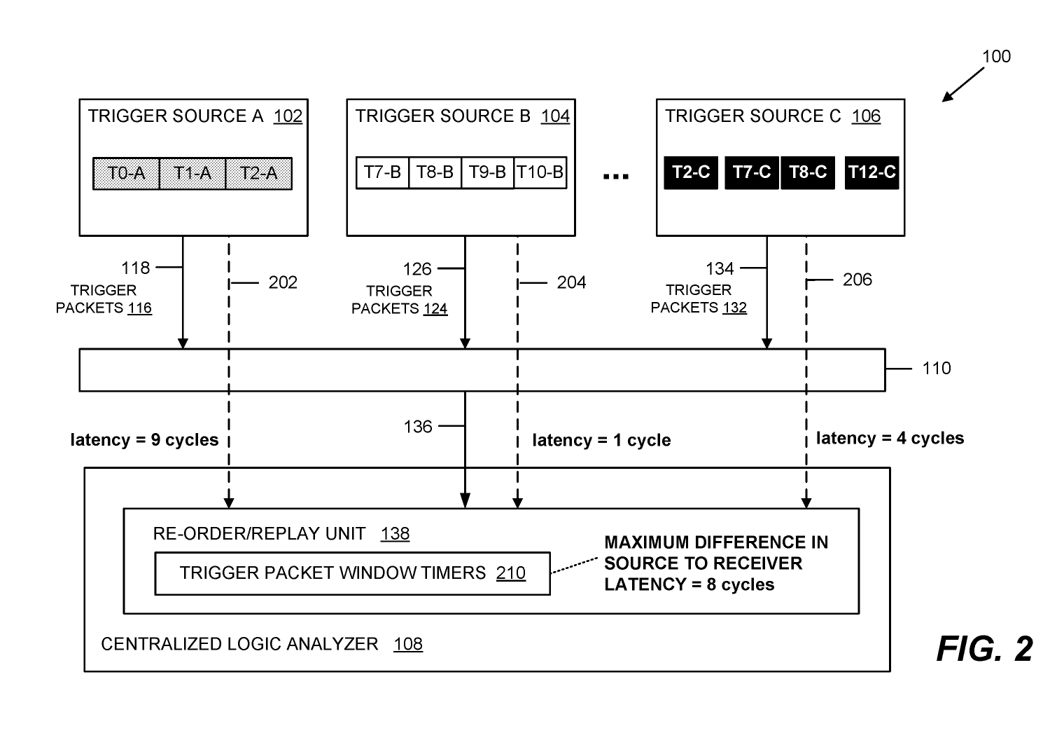

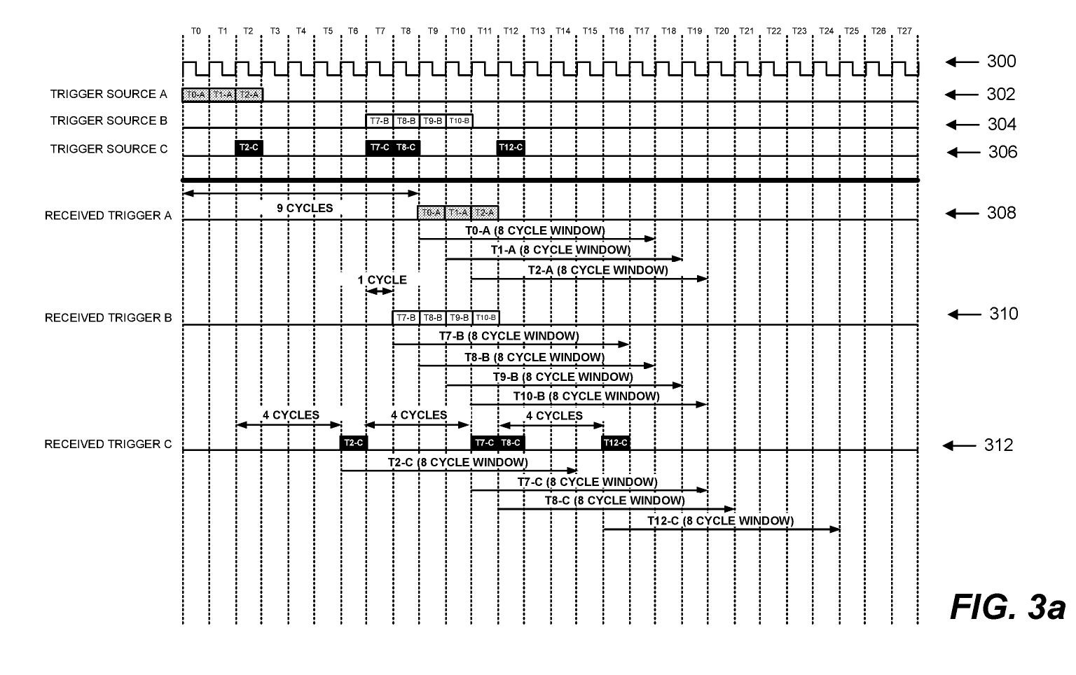

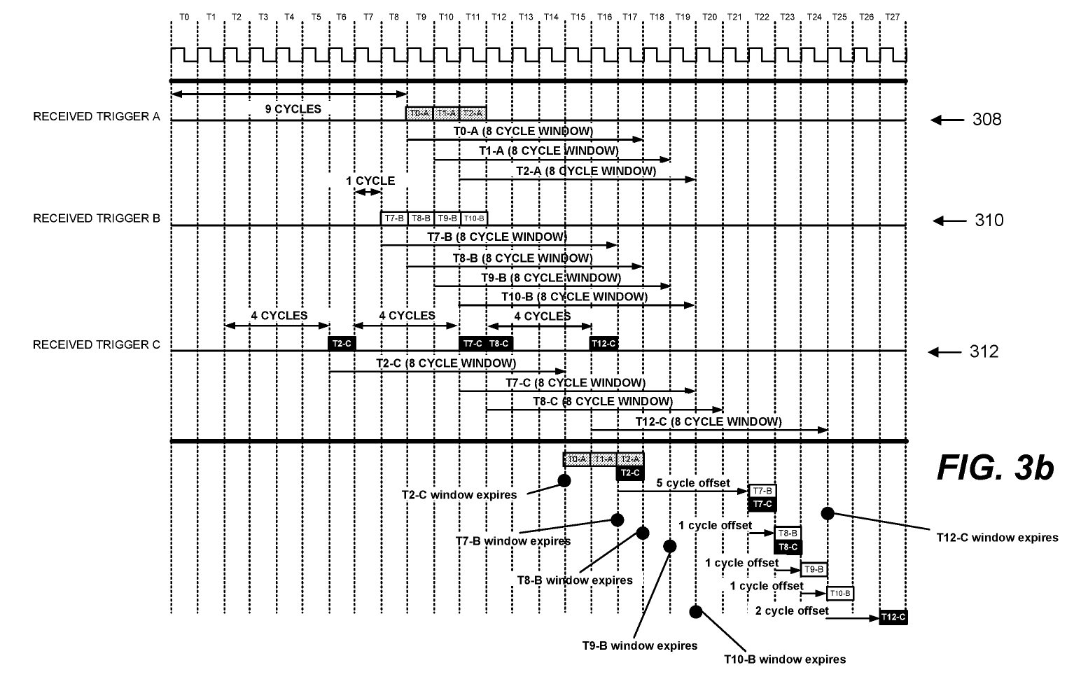

An exemplary embodiment of the operation and structure of the re-order/replay unit 138 is illustrated in FIGS. 2, 3a, and 3b. In the embodiment of FIG. 2, the trigger source A 102 generates three trigger packets 116: trigger packets T0-A, T1-A, and T2-A. Trigger packet T0-A has a corresponding system-generated timestamp T0. Trigger packet T1-A has a corresponding system-generated timestamp T1. Trigger packet T2-A has a corresponding system-generated timestamp T2. The trace source B 104 generates four trigger packets 124: trigger packets T7-B, T8-B, T9-B, and T10-A. Trigger packet T7-B has a corresponding system-generated timestamp T7. Trigger packet T8-B has a corresponding system-generated timestamp T8. Trigger packet T9-B has a corresponding system-generated timestamp T9. Trigger packet T10-B has a corresponding system-generated timestamp T10. The trace source C 106 generates four trigger packets 132: trigger packets T2-C, T7-C, T8-C, and T12-C. Trigger packet T2-C has a corresponding system-generated timestamp T2. Trigger packet T7-C has a corresponding system-generated timestamp T7. Trigger packet T8-C has a corresponding system-generated timestamp T8. Trigger packet T12-C has a corresponding system-generated timestamp T12.

As illustrated in FIG. 2, the trigger packets 116 generated by the trigger source A 102 may have a latency of 9 cycles (reference numeral 202) through the bus interconnect 110. The trigger packets 124 generated by the trigger source B 104 may have a latency of 1 cycle (reference numeral 204) through the bus interconnect 110. The trigger packets 132 generated by the trigger source C 106 may have a latency of 4 cycles (reference numeral 206) through the bus interconnect 110. It should be appreciated that the variable cycle latency may result in the trigger packets from the trigger sources to be received by the re-order/replay unit 138 in a sequence other than the sequence in which they were generated by the system clock signal.

To re-order the trigger packets based on the system-generated timestamps, the re-order/replay unit 138 may generate a trigger packet window timer 210 for each received trigger packet. Each trigger packet window timer 210 may have a duration equal to a maximum difference in source-to-receive latency of the trigger sources in the system 100. In the embodiment of FIG. 2, the maximum latency differential of the trigger sources 102, 104, and 106 is 8 clock cycles. The latency for trigger source 102 is 9 cycles, and the latency for trigger source 104 is 1 cycle, which yields a maximum latency differential of 8 clock cycles.

As described below in more detail, when a trigger packet is received, the re-order/replay unit 138 generates a trigger packet window timer 210 with a value equal to the number of clock cycles representing the maximum latency differential. When a trigger packet window timer 210 expires (i.e., the maximum number of clock cycles elapses), the re-order/replay unit 138 searches all other active trigger packet window timers 210. The timestamp values (TSVAL_{active}) for each active trigger packet window timer 210 may be determined and compared to the timestamp values for the expired trigger packet window (TSVAL_{expired}). If TSVAL_{active} is less than or equal to TSVAL_{expired}, the timestamp values are committed to a first-in-first-out (FIFO) structure with cycle information from the last replayed trigger packet. The re-order/replay unit 138 may empty the FIFO structure as follows. If a FIFO word is available and if the word is cycle info from the last replayed trigger packet, the re-order/replay unit 138 counts that many cycles and then proceeds to read the next entry in the FIFO structure if one is available.

In the embodiment, the FIFO may be implemented via a FIFO buffer comprising N entries, with each entry comprising a predetermined number of bits (e.g., M bits), yielding a total number of bits (e.g., N×M bits). The FIFO buffer may present, for example, a FULL flag out of a write interface to the re-order/replay unit 138. The FIFO buffer may present an EMPTY flag out of a read interface to logic replaying into logic analyzer hardware (e.g., trigger generation unit (TGU)). When the FIFO indicates not empty (e.g., EMPTY flag=0), this means one or more valid M-bit words of data are present in the FIFO. The replay unit may read a word when one is available (again via the EMPTY flag indication) and when it is finished replaying the last trigger to the logic analyzer hardware.

It should be appreciated that incoming trigger packets 118, 126, and 134 may comprise timestamp information and trigger number information. For example, consider an exemplary embodiment in which there are 128 distinct triggers scattered throughout the system 100. The centralized logic analyzer 108 may comprise 128 input trigger ports. The trigger number information may be encoded using, for example, a binary encoding of 7 bits. The 7 bits of trigger number information may be stripped out of the corresponding trigger packet and written into the FIFO as part of each entry's M-bits. This information may be read out of the FIFO by the re-order/replay unit 138 to determine which of the 128 trigger inputs to drive a pulse on. It should be appreciated that triggers may be levels of pulses and the trigger packets may carry that info.

FIGS. 3a & 3b illustrate exemplary timing diagrams for the trigger packet window timers 210 associated with the trigger packets in FIG. 2. FIG. 3a illustrates the generation of the trigger packets from trigger sources 102, 104, and 106 relative to a system clock signal 300. Timeline 302 illustrates that trigger source 102 generates trigger packets T0-A, T1-A, and T2-A at clock cycles T0, T1, and T2, respectively. Timeline 304 illustrates that trigger source 104 generates trigger packets T7-B, T8-B, T9-B, and T10-A at clock cycles T7, T8, T9, and T10, respectively. Timeline 306 illustrates that trigger source 106 generates trigger packets T2-C, T7-C, T8-C, and T12-C at clock cycles T2, T7, T8, and T12, respectively.

Timeline 308 illustrates that the trigger packets T0-A, T1-A, and T2-A are delayed by 9 clock cycles through the variable latency bus interconnect 110. The re-order/replay unit 138 receives the trigger packets T0-A, T1-A, and T2-A at clock cycles T9, T10, and T11, respectively. In response to receiving trigger packet T0-A, a corresponding 8-cycle window timer (T0-A) is generated, which expires at the end of clock cycle T17. In response to receiving trigger packet T1-A, a corresponding 8-cycle window timer (T1-A) is generated, which expires at the end of clock cycle T18. In response to receiving trigger packet T2-A, a corresponding 8-cycle window timer (T2-A) is generated, which expires at the end of clock cycle T19.

Timeline 310 illustrates that the trigger packets T7-B, T8-B, T9-B, and T10-B are delayed by 1 clock cycle through the variable latency bus interconnect 110. The re-order/replay unit 138 receives the trigger packets T7-B, T8-B, T9-B, and T10-B at clock cycles T8, T9, T10, and T11, respectively. In response to receiving trigger packet T7-B, a corresponding 8-cycle window timer (T7-B) is generated, which expires at the end of clock cycle T16. In response to receiving trigger packet T8-B, a corresponding 8-cycle window timer (T8-B) is generated, which expires at the end of clock cycle T17. In response to receiving trigger packet T9-B, a corresponding 8-cycle window timer (T9-B) is generated, which expires at the end of clock cycle T18. In response to receiving trigger packet T10-B, a corresponding 8-cycle window timer (T10-B) is generated, which expires at the end of clock cycle T19.

Timeline 312 illustrates that the trigger packets T2-C, T7-C, T8-C, and T12-C are delayed by 4 clock cycles through the variable latency bus interconnect 110. The re-order/replay unit 138 receives the trigger packets T2-C, T7-C, T8-C, and T12-C at clock cycles T6, T11, T12, and T16, respectively. In response to receiving trigger packet T2-C, a corresponding 8-cycle window timer (T2-C) is generated, which expires at the end of clock cycle T14. In response to receiving trigger packet T7-C, a corresponding 8-cycle window timer (T7-C) is generated, which expires at the end of clock cycle T19. In response to receiving trigger packet T8-C, a corresponding 8-cycle window timer (T8-C) is generated, which expires at the end of clock cycle T20. In response to receiving trigger packet T12-C, a corresponding 8-cycle window timer (T12-C) is generated, which expires at the end of clock cycle T24.

FIG. 3b illustrates the re-ordering of the trigger packets in FIG. 3a according to the 8-cycle window timers. When the T2-C window timer expires at the end of clock cycle T14, the re-order/replay unit 138 may replay the triggers that occurred at T0, T1, and T2 from trigger sources A and C (T0-A, T1-A, T2-A, and T2-C) and cancel the window timers for T0, T1, and T2 from trigger source A (T0-A, T1-A, and T2-A). As further illustrated in FIG. 3b, the T7-B window timer expires at the end of clock T17. Because the latest time for the “last” replayed trigger was T2 (T2-C), there is a 5 cycle differential from 7 (i.e., there are 5 cycles between T7-B and T2-C as they occurred at the corresponding triggers sources). In this manner, it should be appreciated that the re-order/replay unit 138 may preserve the cycle accurate relationship between triggers as they originally occurred.

Following the example in FIG. 3b, when the T7-B window timer expires at the end of clock cycle T17, the re-order/replay unit 138 may replay the triggers T7-B and T7-C and cancel the T7-C window timer. When the T8-B window timer expires at the end of clock cycle T17, the re-order/replay unit 138 may replay the triggers T8-B and T8-C and cancel the T8-C window timer. When the T9-B window timer expires at the end of clock cycle T18, the re-order/replay unit 138 may replay the trigger T9-B. When the T10-B window timer expires at the end of clock cycle T19, the re-order/replay unit 138 may replay the trigger T10-B. When the T12-C window timer expires at the end of clock cycle T24, the re-order/replay unit 138 may replay the trigger T12-C.

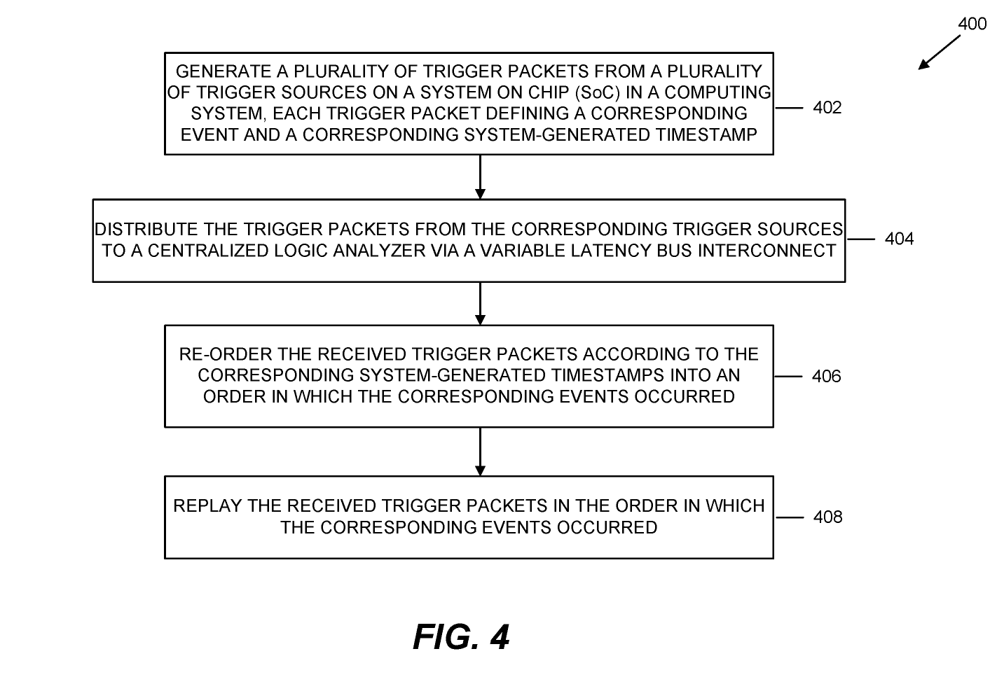

FIG. 4 illustrates an exemplary embodiment of a method 400 implemented in the system 100. At block 402, a plurality of triggers sources on a system on chip (SoC) in a computing system may generate trigger packets. As described above, each trigger packet may define a corresponding event and a corresponding system-generated timestamp relative to a system clock signal. At block 404, the trigger packets may be distributed from the corresponding trigger sources to the centralized logic analyzer 108 via the variable latency bus interconnect 110. Each trigger source may have a corresponding latency (i.e., a number of clock cycles) through the bus interconnect 110. The re-order/replay unit 138 may receive the variably delayed trigger packets. At block 406, the re-order/replay unit 138 re-orders the received trigger packets according to the corresponding system-generated timestamps into an order or sequence in which the corresponding events occurred in the computing system. At block 408, the received trigger packets are replayed in the order in which the corresponding events occurred in the computing system.

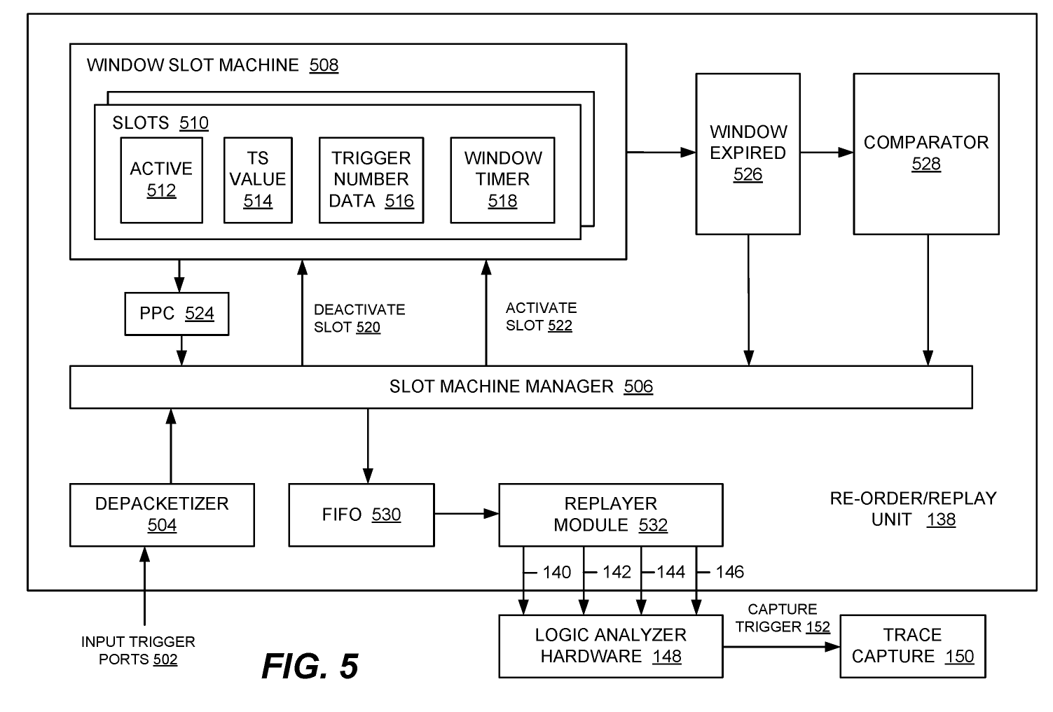

FIG. 5 illustrates an exemplary embodiment of an implementation of the re-order/replay unit 138. As illustrated in FIG. 5, the re-order/replay unit 138 comprises a depacketizer module 504 for receiving trigger packets via input trigger ports 502 from the bus interconnection network 110. Each trigger packet may include trigger number information and timestamp value information. The depacketizer module 504 may extract the trigger number information and timestamp value information, which may be forwarded to a slot machine manager 506. The slot machine manager 506 manages a window slot machine 508 comprising a slot 510 for each of the trigger packet window timers 210 (FIG. 2). As further illustrated in FIG. 5, a slot 510 comprises an active state machine 512, a timestamp value 514, trigger number data 516, and a window timer 518. The active state machine 512 maintains a state value indicating whether the corresponding slot 510 is active or inactive. The active/inactive state values for the slots 510 may be passed to, for example, a parallel prefix computator (PPC) 524. PPC 214 may provide an index to the slot machine manager 506 indicating an available location in the window slot machine 508 for activating new slots 510 via interface 522.

The window slot machine 508 may be connected to a window expired decision module 526 for determining when the window timers 518 for active slots 510 have expired. The window expired decision module 526 may be connected to the slot machine manager 506. The window expired decision module 526 may provide to the slot machine manager 506 an index identifying slot(s) 510 having expired window timer(s) 518.

As mentioned above, when a window timer 518 expires, the re-order/replay unit 138 may determine all other active trigger packet window timers 518. The timestamp values (TSVAL_{active}) for each active trigger packet window timer 518 may be determined and compared to the timestamp values for the expired trigger packet window (TSVAL_{expired}). If TSVAL_{active} is less than or equal to TSVAL_{expired}, the timestamp values are committed to a first-in-first-out (FIFO) structure 530 with cycle information from the last replayed trigger packet. As illustrated in the embodiment of FIG. 5, the window expired decision module 526 may send an enable command to a comparator 528 to compare the appropriate timestamp values. The comparator 528 may provide a slot index to the slot machine manager 506 to identify appropriate slots 510 for which the window timer(s) 518 are to be canceled. The slot machine manager 506 may deactivate slots 510 via a connection 520 to the window slot machine 508.

As further illustrated in FIG. 5 and generally described above in connection with FIG. 3b, the re-order/replay unit 138 may empty the FIFO structure 530 as follows. If a FIFO word is available and if the word has cycle info from the last replayed trigger packet, the re-order/replay unit 138 counts that many cycles and then proceeds to read the next entry in the FIFO structure 530 if one is available. The FIFO structure 530 may present, for example, a FULL flag out of a write interface to a replayer module 532. The FIFO structure 530 may present an EMPTY flag out of a read interface to the replayer module 532 into logic analyzer hardware 148. When the FIFO 530 indicates not empty (e.g., EMPTY flag=0), this means one or more valid M-bit words of data are present in the FIFO 530. The replayer module 532 may read a word when one is available (again via the EMPTY flag indication) and when it is finished replaying the last trigger to the logic analyzer hardware 148.

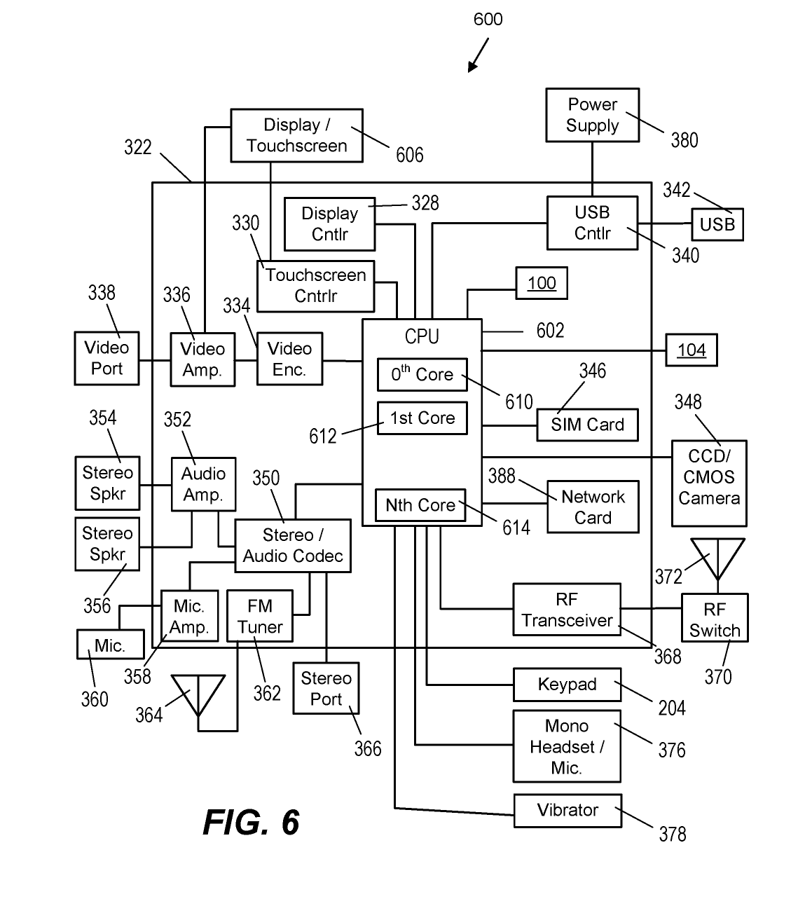

As mentioned above, the system 100 may be incorporated into any desirable computing system. FIG. 6 illustrates the system 100 incorporated in an exemplary portable computing device (PCD) 600. The system 100 may be included on the SoC 601, which may include a multicore CPU 602. The multicore CPU 602 may include a zeroth core 610, a first core 612, and an Nth core 614. One of the cores may comprise, for example, a graphics processing unit (GPU) with one or more of the others comprising the CPU 104 (FIG. 1). According to alternate exemplary embodiments, the CPU 602 may also comprise those of single core types and not one which has multiple cores, in which case the CPU 602 and the GPU may be dedicated processors, as illustrated in system 100.

A display controller 628 and a touch screen controller 630 may be coupled to the CPU 602. In turn, the touch screen display 625 external to the on-chip system 601 may be coupled to the display controller 616 and the touch screen controller 618.

FIG. 6 further shows that a video encoder 620, e.g., a phase alternating line (PAL) encoder, a sequential color a memoire (SECAM) encoder, or a national television system(s) committee (NTSC) encoder, is coupled to the multicore CPU 602. Further, a video amplifier 622 is coupled to the video encoder 620 and the touch screen display 625. Also, a video port 624 is coupled to the video amplifier 622. As shown in FIG. 6, a universal serial bus (USB) controller 626 is coupled to the multicore CPU 602. Also, a USB port 628 is coupled to the USB controller 626. The external memory system and a subscriber identity module (SIM) card may also be coupled to the multicore 602. The external memory system may comprise DRAM modules 112, 114, 120, and 122 (FIG. 1), as described above. One or more aspects of the system 100 (FIG. 1) may be coupled to the 602 (e.g., symmetric memory channel interleaver 106).

Further, as shown in FIG. 6, a digital camera 630 may be coupled to the multicore CPU 602. In an exemplary aspect, the digital camera 630 is a charge-coupled device (CCD) camera or a complementary metal-oxide semiconductor (CMOS) camera.

As further illustrated in FIG. 6, a stereo audio coder-decoder (CODEC) 632 may be coupled to the multicore CPU 602. Moreover, an audio amplifier 634 may coupled to the stereo audio CODEC 632. In an exemplary aspect, a first stereo speaker 636 and a second stereo speaker 638 are coupled to the audio amplifier 634. FIG. 6 shows that a microphone amplifier 640 may be also coupled to the stereo audio CODEC 632. Additionally, a microphone 642 may be coupled to the microphone amplifier 640. In a particular aspect, a frequency modulation (FM) radio tuner 644 may be coupled to the stereo audio CODEC 632. Also, an FM antenna 646 is coupled to the FM radio tuner 644. Further, stereo headphones 648 may be coupled to the stereo audio CODEC 632.

FIG. 6 further illustrates that a radio frequency (RF) transceiver 650 may be coupled to the multicore CPU 602. An RF switch 652 may be coupled to the RF transceiver 650 and an RF antenna 654. As shown in FIG. 6, a keypad 656 may be coupled to the multicore CPU 602. Also, a mono headset with a microphone 658 may be coupled to the multicore CPU 602. Further, a vibrator device 680 may be coupled to the multicore CPU 602.

FIG. 6 also shows that a power supply 662 may be coupled to the on-chip system 601. In a particular aspect, the power supply 662 is a direct current (DC) power supply that provides power to the various components of the PCD 600 that require power. Further, in a particular aspect, the power supply is a rechargeable DC battery or a DC power supply that is derived from an alternating current (AC) to DC transformer that is connected to an AC power source.

FIG. 6 further indicates that the PCD 600 may also include a network card 664 that may be used to access a data network, e.g., a local area network, a personal area network, or any other network. The network card 664 may be a Bluetooth network card, a WiFi network card, a personal area network (PAN) card, a personal area network ultra-low-power technology (PeANUT) network card, a television/cable/satellite tuner, or any other network card well known in the art. Further, the network card 664 may be incorporated into a chip, i.e., the network card 664 may be a full solution in a chip, and may not be a separate network card 664.

It should be appreciated that one or more of the method steps described herein may be stored in the memory as computer program instructions, such as the modules described above. These instructions may be executed by any suitable processor in combination or in concert with the corresponding module to perform the methods described herein.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example.

Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the Figures which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, NAND flash, NOR flash, M-RAM, P-RAM, R-RAM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

Alternative embodiments will become apparent to one of ordinary skill in the art to which the invention pertains without departing from its spirit and scope. Therefore, although selected aspects have been illustrated and described in detail, it will be understood that various substitutions and alterations may be made therein without departing from the spirit and scope of the present invention, as defined by the following claims.

What is claimed is:

1. A method for distributing and replaying trigger packets via a variable latency bus interconnect in a trace system, the method comprising:
generating a plurality of trigger packets from a plurality of trigger sources on a system on chip, each trigger packet defining a corresponding event and a corresponding system-generated timestamp;
distributing the plurality of trigger packets from the corresponding trigger sources to a centralized logic analyzer via a variable latency bus interconnect;
re-ordering the received trigger packets according to the corresponding system-generated timestamps into an order in which the corresponding events occurred; and
replaying the received trigger packets in the order in which the corresponding events.

2. The method of claim 1, wherein the plurality of trigger sources comprises one of a memory controller, a central processing unit (CPU), and a system cache.

3. The method of claim 1, wherein the plurality of trigger sources reside on a mobile system on chip SoC.

4. The method of claim 1, wherein the plurality of trigger sources are incorporated in one of a server and a portable computing device.

5. The method of claim 4, wherein the portable computing device comprises one of a smart phone, a tablet computer, and a wearable device.

6. The method of claim 1, wherein the re-ordering the received trigger packets according to the corresponding system-generated timestamps comprises: generating and managing a trigger packet window timer for each of the received trigger packets.

7. The method of claim 6, further comprising:
determining a first trigger packet window timer associated with a first received trigger packet has expired; and
canceling one or more other trigger packet window timers by comparing the system-generated timestamps for the first trigger packet window timer and the one or more other trigger packet window timers.

8. A system for distributing and replaying trigger packets via a variable latency bus interconnect in a trace system, the system comprising:
means for generating a plurality of trigger packets from a plurality of trigger sources in a computing system, each trigger packet defining a corresponding event and a corresponding system-generated timestamp;
means for distributing the plurality of trigger packets from the corresponding trigger sources to a centralized logic analyzer via a variable latency bus interconnect;
means for re-ordering the received trigger packets according to the corresponding system-generated timestamps into an order in which the corresponding events occurred in the computing system; and
means for replaying the received trigger packets in the order in which the corresponding events occurred in the computing system.

9. The system of claim 8, wherein the plurality of trigger sources comprises one of a memory controller, a central processing unit (CPU), and a system cache.

10. The system of claim 8, wherein the plurality of trigger sources reside on a mobile system on chip (SoC).

11. The system of claim 8, wherein the computing system comprises one of a server and a portable computing device.

12. The system of claim 11, wherein the portable computing device comprises one of a smart phone, a tablet computer, and a wearable device.

13. The system of claim 8, wherein the means for re-ordering the received trigger packets according to the corresponding system-generated timestamps comprises: means for generating and managing a trigger packet window timer for each of the received trigger packets.

14. The system of claim 13, further comprising:
means for determining a first trigger packet window timer associated with a first received trigger packet has expired; and
means for canceling one or more other trigger packet window timers by comparing the system-generated timestamps for the first trigger packet window timer and the one or more other trigger packet window timers.

15. A computer program embodied in a computer readable medium and executed by a processing device for distributing and replaying trigger packets via a variable latency bus interconnect in a trace system, the computer program comprising logic configured to:
generate a plurality of trigger packets from a plurality of trigger sources in a computing system, each trigger packet defining a corresponding event and a corresponding system-generated timestamp;
distribute the plurality of trigger packets from the corresponding trigger sources to a centralized logic analyzer via a variable latency bus interconnect;
re-order the received trigger packets according to the corresponding system-generated timestamps into an order in which the corresponding events occurred in the computing system; and
replay the received trigger packets in the order in which the corresponding events occurred in the computing system.

16. The computer program of claim 15, wherein the plurality of trigger sources comprises one of a memory controller, a central processing unit (CPU), and a system cache.

17. The computer program of claim 15, wherein the plurality of trigger sources reside on a mobile system on chip (SoC).

18. The computer program of claim 15, wherein the computing system comprises one of a server and a portable computing device.

19. The computer program of claim 18, wherein the portable computing device comprises one of a smart phone, a tablet computer, and a wearable device.

20. The computer program of claim 15, wherein the logic configured to re-order the received trigger packets according to the corresponding system-generated timestamps comprises: logic configured to generate and manage a trigger packet window timer for each of the received trigger packets.

21. The computer program of claim 20, wherein the logic configured to re-order the received trigger packets comprises:
logic configured to determine a first trigger packet window timer associated with a first received trigger packet has expired; and
logic configured to cancel one or more other trigger packet window timers by comparing the system-generated timestamps for the first trigger packet window timer and the one or more other trigger packet window timers.

22. A system comprising:
a plurality of trigger sources for generating a plurality of trigger packets, each trigger packet defining a corresponding event and a corresponding system-generated timestamp;
a variable latency bus interconnect electrically coupled to the plurality of trigger sources for distributing the plurality of trigger packets to a centralized logic analyzer; and
the centralized logic analyzer configured to:
receive the trigger packets via the variable latency bus interconnect;
re-order the received trigger packets according to the corresponding system-generated timestamps into an order in which the corresponding events occurred; and
replay the received trigger packets in the order in which the corresponding events occurred.

23. The system of claim 22, wherein the plurality of trigger sources comprises one of a memory controller, a central processing unit (CPU), and a system cache.

24. The system of claim 22, wherein the plurality of trigger sources, the variable latency bus interconnect, and the centralized logic analyzer reside on a system on chip (SoC).

25. The system of claim 22, the wherein the SoC is incorporated on one of a server and a portable computing device.

26. The system of claim 25, wherein the portable computing device comprises one of a smart phone, a tablet computer, and a wearable device.

27. The system of claim 22, wherein the centralized logic analyzer is further configured to: generate and manage a trigger packet window timer for each of the received trigger packets.

28. The system of claim 27, wherein the logic configured to re-order the received trigger packets comprises:
logic configured to determine a first trigger packet window timer associated with a first received trigger packet has expired.

29. The system of claim 28, further comprising:
logic configured to cancel one or more other trigger packet window timers by comparing the system-generated timestamps for the first trigger packet window timer and the one or more other trigger packet window timers.

30. The system of claim 27, wherein the logic configured to generate and manage a trigger packet window timer for each of the received trigger packets comprises a first-in-first-out (FIFO) buffer and a replayer module.
